(19) United States
(12) Patent Application Publication
(10) Pub. No.: US 2024/0196235 A1
(43) Pub. Date: Jun. 13, 2024

(54) SYSTEMS AND METHODS FOR CONFIGURING A MOBILE ELECTRONIC DEVICE

(71) Applicant: INDOOR ROBOTICS LTD., Ramat-Gan (IL)

(72) Inventor: AMIT MORAN, TEL-AVIV (IL)

(21) Appl. No.: 18/076,415

(22) Filed: Dec. 7, 2022

(51) Int. Cl. H04W 24/04

(52) U.S. Cl. CPC H04W 24/04; H04W 84/18

(57) ABSTRACT

A method for enabling configuration of a mobile electronic device, including collecting motion measurements of the mobile electronic device, identifying a configuration gesture or a configuration position of the mobile electronic device based on the motion measurements, updating a memory address in a memory included in the mobile electronic device to indicate that the mobile electronic device is in a configuration state, when the mobile electronic device is in the configuration state, activating an ad-hoc wireless network that enables wireless communication between the mobile electronic device and a remote device, enabling another device to communicate with the mobile electronic device via the ad-hoc wireless network, the other device receiving a management interface via the ad-hoc wireless network, where the management interface enables the other device to input data into a configurable memory address of the electronic device.

### FIELD AND BACKGROUND

The invention, in some embodiments thereof, relates to configuring a mobile electronic device.

Mobile electronic devices include laptops, cellular phones, tablet computers, IoT devices, cameras, robots, and other devices used for leisure and to execute many tedious tasks, such as surveillance, monitoring, cleaning, etc. The electronic devices are transported from the manufacturing site to the stores where they are purchased or to the customer's residence or office. Many times, there is a need to configure the mobile electronic device, for example by inputting an email address to which alerts are sent, configuring thresholds used by the electronic device to determine whether or not to perform a task, such as whether or not to clean a table or a window, configure a wireless network to be used by the electronic device, coordinates of docking stations and the like.

Many times, such configuration is enabled by connecting an input device, such as a keyboard or a mouse, to a connector located at the body or the housing of the mobile electronic device. The input device adds complexity to the configuration process of the electronic device, depends on human labor for typing the configuration properties, makes the robot more difficult for sealing against water, and makes it more exposed to cyber security attacks.

In other cases, the configuration process starts with a certain key-pressing sequence on the electronic device.

### SUMMARY

In one aspect of the invention a method is provided for enabling configuration of a mobile electronic device, the method comprising collecting motion measurements of the mobile electronic device, identifying a configuration gesture or a configuration position of the mobile electronic device based on the motion measurements, updating a memory address in a memory included in the mobile electronic device to indicate that the mobile electronic device is in a configuration state, when the mobile electronic device is in the configuration state, activating an ad-hoc wireless network that enables wireless communication between the mobile electronic device and a remote device, enabling another device to communicate with the mobile electronic device via the ad-hoc wireless network, the other device receiving a management interface via the ad-hoc wireless network, wherein the management interface enables the other device to input data into a configurable memory address of the electronic device.

In some cases, the method further comprises creating a configuration vector that represents the motion measurements of the mobile electronic device.

In some cases, the method further comprises comparing the configuration vector to a reference vector stored in the memory of the mobile robot and updating the memory address to a configuration state in case a distance between the configuration vector and the reference vector is smaller than a threshold.

In some cases, comparing the configuration vector to a reference vector only in case a total time duration between a first of the motion measurements and a last of the motion measurements is higher than a threshold.

In some cases, comparing the configuration vector to a reference vector only in case a total time duration between a first of the motion measurements and a last of the motion measurements is lower than a threshold.

In some cases, identifying the configuration position comprises determining that the collected measurements of the mobile electronic device satisfy a reference position for a duration longer than a threshold.

In some cases, identifying the configuration gesture comprises identifying movement in a single dimension.

In some cases, the configuration position is identified only after collecting measurements that match the configuration position for a time duration that matches a predefined condition.

In some cases, the method further comprises receiving a password or another code from the other device when the other device requests permission to connect with the mobile electronic device via the wireless network.

In some cases, the ad-hoc wireless network is assigned a name, wherein the name comprises a unique identifier of the mobile electronic device.

In some cases, the method further comprises the other device receiving a management interface via the ad-hoc wireless network, wherein the management interface enables the other device to input data into a configurable memory address of the electronic device.

In some cases, the management interface is a browser or a dedicated software application capable of remotely controlling applications operating on the mobile electronic device.

In some cases, the method further comprises securing the mobile electronic device by a configuration device, the configuration device moving the mobile electronic device according to the configuration gesture, the configuration device releasing the mobile electronic device.

In some cases, the configuration device releases the mobile electronic device on a movable surface that carries the mobile electronic device to a storage location.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 shows a method for identifying a configuration gesture by a mobile electronic device, in accordance with some embodiments of the invention;

FIG. 2 shows a method for providing configuration data to a mobile electronic device, in accordance with some embodiments of the invention;

FIG. 3 shows a mobile electronic device capable of performing the method of configuration using a remote device, in accordance with some embodiments of the invention.

### DETAILED DESCRIPTION

The invention, in some embodiments thereof, relates to methods for enabling the configuration of a mobile electronic device. The technical challenge is to configure a mobile electronic device in a secure manner, for example without coupling an external device such as a keyboard, to a connector of the electronic device and without using a button in the electronic device's body or housing. When using a keyboard or another input device, the user of the input device inputs credentials, such as a password or a code, to input the configuration properties and values. This way, the configuration takes a lot of time for typing the values for each mobile electronic device and it's sufficient to know the code to change the configurations.

The invention, in some embodiments thereof, discloses a method for enabling the configuration of the mobile electronic device without using the keyboard, buttons, or another input device. Instead, a person or a machine moves the mobile electronic device in a specific motion pattern. Sensors of the mobile electronic device identify the specific motion pattern and activate an ad-hoc wireless network via which a remote device controls the mobile electronic device's network properties and connects the mobile electronic device to a second wireless network used to input the configuration values.

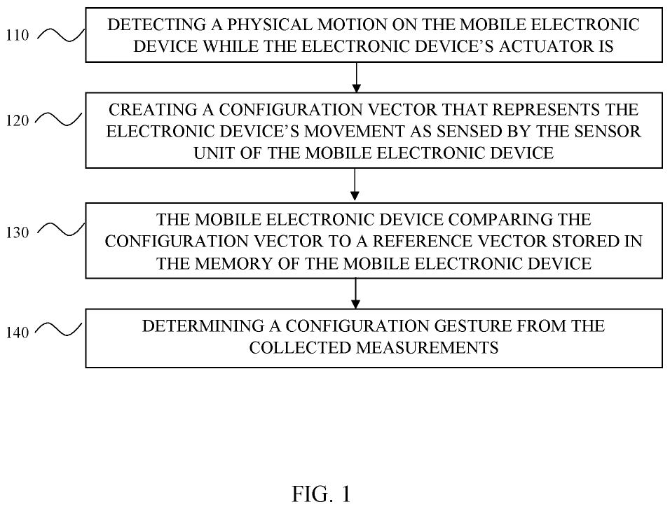

FIG. 1 shows a method for identifying a configuration gesture by a mobile electronic device, in accordance with some embodiments of the invention. The mobile electronic device may be an aerial vehicle or any other type of movable robot having an actuator. The method may be done by a person that purchased the mobile electronic device, an employee of an organization that purchased the mobile electronic device, an operator of the mobile electronic device, a technician, and the like. In some cases, the method may be automated, such that a fleet of hundreds of mobile robots is placed on a conveyor belt or another mechanism that moves the mobile robots in a specific order in order for the mobile electronic devices to move to a configuration device and initiate the configuration process. The automated process may specifically be used when wishing to configure a fleet of mobile electronic devices, for example, a fleet of drones or other mobile robots. This way, the configuration process may be fully automated.

In such a case, the method comprises the configuration device securing the mobile electronic device. The securing may be done using movable arms of the configuration device or by another mechanism, such as springs. Then, the method comprises the configuration device moving the mobile electronic device according to the configuration gesture. After performing the configuration gesture or configuration position, the configuration device releases the mobile electronic device to enable the configuration device to secure and move another mobile electronic device. In some cases, the configuration device releases the mobile electronic device on a movable surface that carries the mobile electronic device to a storage location. The movable surface may be a conveyor belt and the storage location may be a box in which the mobile electronic devices are stored when being configured by a remote device.

At 110, the method discloses detecting a physical motion on the mobile electronic device while the electronic device's actuator is disabled. The detection is done by a sensor unit of the mobile electronic device. The sensor unit comprises motion sensors, such as a gyroscope, an accelerometer, an inertial measurement unit (IMU), or other sensors selected by a person skilled in the art. The sensor unit of the mobile electronic device is an electronic device that measures and reports a body's specific force, angular rate, and sometimes the orientation of the body, using a combination of accelerometers, gyroscopes, and sometimes magnetometers.

Step 120 discloses creating a configuration vector that represents the electronic device's movement as sensed by the sensor unit of the mobile electronic device. The configuration vector comprises an array of forces' measurements and time stamps for each of the forces. For example, the first value in the configuration vector is yaw of 0.2 m/s\hat{ }2 at 10:22:34:55, the second value in the configuration vector is yaw of 0.4 m/s\hat{ }2 and roll of 0.6 m/s\hat{ }2 at 10:22:34:75, the third value in the configuration vector is a roll of 0.4 m/s\hat{ }2 at 10:22:34:95, etc.

Step 130 discloses the mobile electronic device comparing the configuration vector to a reference vector stored in the memory of the mobile electronic device. Such a comparison may be done by a set of rules stored in the memory of the mobile electronic device. The comparison may be performed by a processor of the mobile electronic device. The comparison may be done using a similarity function executed by the processor of the mobile electronic device. The comparison may be disabled in case the total time duration of the motion is higher than a predefined threshold, for example, 3.5 seconds.

In some cases, identifying the configuration gesture may be performed by identifying movement in a single dimension, for example, maneuver in the roll dimension. In some cases, identifying the configuration gesture may comprise identifying a configuration position, for example, a position in which the mobile electronic device is placed in an upside-down configuration, and the acceleration measured is minus 9.8 m/s\hat{ }2 instead of plus 9.8 m/s\hat{ }2, or acceleration in the range of −0.5 to 0.5 m/s\hat{ }2, in which the configuration position is sidewards. In some cases, the configuration position is identified only after collecting measurements that match the configuration position for a time duration that matches a predefined condition, for example, a time duration longer than 5 seconds and shorter than 3 minutes.

Step 140 discloses determining a configuration gesture from the collected measurements. The configuration gesture may be determined in case the similarity between the vector of the motion measurements and the reference vector stored in the memory of the mobile electronic device is higher or lower than a predefined value.

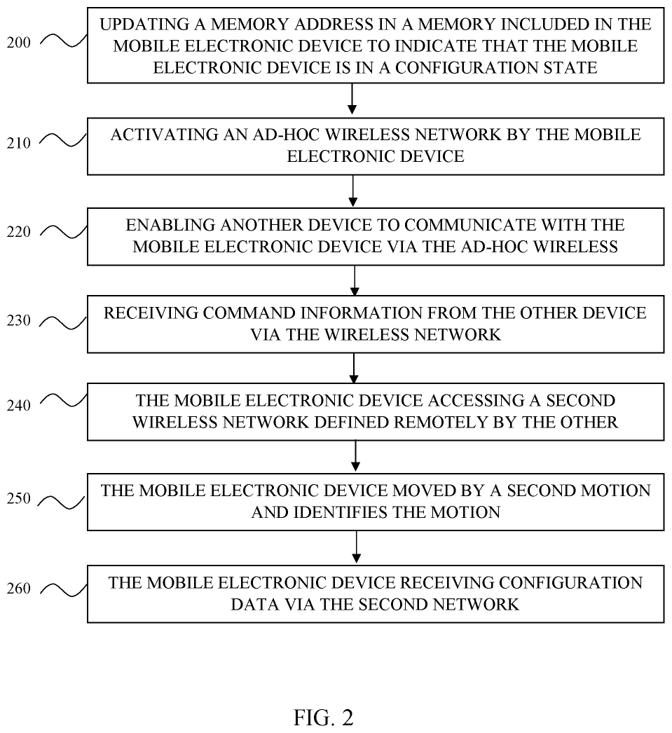

FIG. 2 shows a method for providing configuration data to a mobile electronic device, in accordance with some embodiments of the invention;

Step 200 discloses updating a memory address in a memory included in the mobile electronic device to indicate that the mobile electronic device is in a configuration state. Prior to identifying the configuration gesture or the configuration position by the sensor unit of the mobile electronic device, the configuration status of the mobile electronic device is “sleep state”.

Step 210 discloses activating an ad-hoc wireless network by the mobile electronic device. The ad-hoc wireless network's name may comprise a unique identifier of the mobile electronic device to clarify that the mobile electronic device being configured is a specific mobile electronic device and prevent confusion and repetition of the configuration process. The unique identifier may be a serial number of the mobile electronic device, or a number agreed upon with the customer or user of the mobile electronic device, for example when purchasing the electronic device, or as part of the invoice. This way, when buying and configuring a fleet of multiple mobile electronic devices, the person or device managing the configuration process knows which electronic device is configured in an intuitive manner.

Activating the ad-hoc wireless network may be done by changing a value in a memory address of the mobile electronic device. Such value change may result from a command from the processor of the mobile electronic device. When the value changes, the ad-hoc Wireless network is activated and the wireless receiver of the mobile electronic device may receive signals from a remote device, such as over a Wi-Fi network, Blue-Tooth channel and the like. The term ad-hoc wireless network is defined as a decentralized type of wireless network. The network is ad-hoc because it does not rely on a pre-existing infrastructure, such as access points in wireless networks. Instead, each node participates in routing by forwarding data to other nodes, so the determination of which nodes forward data is made dynamically on the basis of network connectivity and the routing algorithm in use. In the Windows operating system, ad hoc is a communication mode (setting) that allows computers to directly communicate with each other without a router.

Step 220 discloses enabling another device to communicate with the mobile electronic device via the ad-hoc wireless network. In some cases, the other device inputs a password or another code when requesting permission to connect with the ad-hoc wireless network activated by the mobile electronic device. If the password or code matches a code stored in the memory of the electronic device, the other device receives permission to connect to the ad-hoc wireless network and hence to communicate with the mobile electronic device via the ad-hoc wireless network.

Step 230 discloses receiving command information from the other device via the wireless network. The other device may use a management interface to input data into a configurable memory address of the electronic device. The management interface enables the other device to update the wireless communication settings of the mobile electronic device, for example by selecting a second wireless network to be used by the mobile electronic device. The management interface may be a browser or a dedicated software application capable of remotely controlling applications running and/or operating on the mobile electronic device, for example by inputting a username and a password into web-based portals or wireless networks. The management interface comprises credentials, for example, a secret such as a password or an encrypted data element, in order to verify that the management interface is authorized to control the mobile electronic device via the ad-hoc wireless network.

Step 240 discloses the mobile electronic device accessing a second wireless network defined remotely by the other device. For example, at first, the mobile electronic device does not have the information required to select the wireless network to be used when configuring the mobile electronic device. Once controlled by the remote device via the management interface, the remote device sends information about the second wireless network, for example a network identifier, network name, network password, to the mobile electronic device. Then, the mobile electronic device accesses the second wireless network, such as a Wi-Fi network, connected to the internet.

Step 250 discloses the mobile electronic device moved by a second motion and identifies the motion. The motion may be returning the mobile electronic device to an initial position. For example, the initial position may be with a display device of the mobile electronic device heading upwards, or downwards. The user may first place the mobile electronic device in the initial position, then move the mobile electronic device to the configuration position, and then move the mobile electronic device back to the initial position to enable the mobile electronic device to receive the configuration data via the second wireless network.

The motion may be done by an electronic device having gripping arms and a management unit that controls the movement of the gripping arms. The motion may be done by a person, such as a user of the electronic device.

Step 260 discloses the mobile electronic device receiving configuration data via the second network.

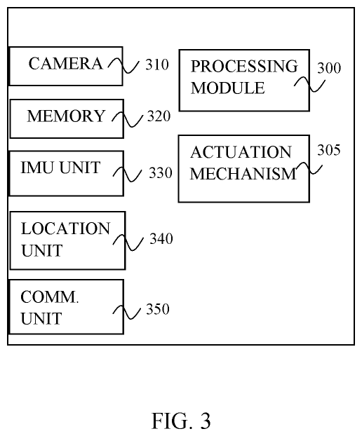

FIG. 3 shows a mobile electronic device for capable of the method of configuration using a remote device, in accordance with some embodiments of the invention.

The mobile electronic device comprises a processing module 300 configured to process the aerial device's missions, and other actions performed by the mobile electronic device. Thus, the processing module 300 is coupled to the actuation mechanism 305 configured to move the mobile electronic device. Such coupling may be via an electrical channel or cable, wireless communication, magnetic-based communication, optical fibers and the like. The processing module 300 may send a command to the actuation mechanism 305 to move to a certain location in order to perform a mission, such as monitoring, cleaning, moving goods from one place to another, and the like. The command may include instructions as to how to move to the certain location. The processing module 300 as defined herein may be a processor, controller, microcontroller and the like.

The mobile electronic device may comprise an actuation mechanism 305 for moving the mobile electronic device from one place to another. The actuation mechanism 305 may comprise a motor, an actuator and any mechanism configured to maneuver a physical member desired by a person skilled in the art. The actuation mechanism 305 may comprise a rotor of some sort, or another mechanism enabling the mobile electronic device to fly. The actuation mechanism 305 is coupled to a power source, such as a battery or a renewable energy member, such as a solar panel in case the area comprises or is adjacent to an outdoor area accessible to the mobile electronic device. The actuation mechanism 305 may move the mobile electronic device in two or three dimensions.

The mobile electronic device may comprise a camera unit 310 including one or more cameras for capturing images and/or videos. The cameras of the camera unit 310 may be mechanically coupled to arms or other tilting mechanisms for changing the position of one or more of the cameras relative to the heading of the mobile electronic device. The processing module 300 may control the properties of the images captured by the cameras, such as size, resolution, grayscale or RGB and the like.

The mobile electronic device comprises a memory 320 for storing data. The memory 320 comprises instructions to activate an ad-hoc wireless network in response to identifying a motion identified by sensors of the mobile electronic device. The memory 320 may also store a unique name to be used as the name of the ad-hoc wireless network activated by the mobile electronic device in response to identifying the configuration gesture. The memory 320 may also store a code or password to be inputted by a user of a remote device when requesting access to the wireless network activated by the mobile electronic device.

The mobile electronic device comprises an inertial measurement unit (IMU) 330 configured to measure the electronic device's linear acceleration and angular velocities. The measurements collected by the IMU 330 may be transmitted to the processing module 300 configured to process the measurements. The IMU 330 may comprise one or more sensors, such as an accelerator, a gyroscope, a compass or magnetometer, a barometer, and any the like.

The mobile electronic device may also comprise a Location unit 340 configured to locate the mobile electronic device's location. The location unit 340 may include a GPS receiver, a wireless receiver that enables triangulation technique to locate the mobile electronic device, other sensors used to locate the mobile electronic device, and additional techniques desired by a person skilled in the art.

The mobile electronic device also comprises a wireless communication unit 350 via which the remote device communicates with the mobile electronic device. The wireless communication module 350 is configured to receive wireless signals, such as data transmitted over RF, Bluetooth, and Wi-Fi channels. The wireless communication network 350 may comprise an antenna for receiving and sending signals. In some cases, wireless communication network 350 may be deactivated in an initial state and activated only after identifying the configuration gesture applied on the mobile device.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the invention. To the extent that section headings are used, they should not be construed as necessarily limiting. In addition, any priority document(s) of this application is/are hereby incorporated herein by reference in its/their entirety.

What is claimed is:

1. A method for enabling configuration of a mobile electronic device, the method comprising:
collecting motion measurements of the mobile electronic device;
identifying a configuration gesture or a configuration position of the mobile electronic device based on the motion measurements;
updating a memory address in a memory included in the mobile electronic device to indicate that the mobile electronic device is in a configuration state;
when the mobile electronic device is in the configuration state, activating an ad-hoc wireless network that enables wireless communication between the mobile electronic device and a remote device;
enabling another device to communicate with the mobile electronic device via the ad-hoc wireless network;
the other device receiving a management interface via the ad-hoc wireless network;
wherein the management interface enables the other device to input data into a configurable memory address of the electronic device.

2. The method of claim 1, further comprising creating a configuration vector that represents the motion measurements of the mobile electronic device.

3. The method of claim 2, further comprising comparing the configuration vector to a reference vector stored in the memory of the mobile robot and updating the memory address to a configuration state in case a distance between the configuration vector and the reference vector is smaller than a threshold.

4. The method of claim 3, wherein comparing the configuration vector to a reference vector only in case a total time duration between a first of the motion measurements and a last of the motion measurements is higher than a threshold.

5. The method of claim 3, wherein comparing the configuration vector to a reference vector only in case a total time duration between a first of the motion measurements and a last of the motion measurements is lower than a threshold.

6. The method of claim 1, wherein identifying the configuration position comprises determining that the collected measurements of the mobile electronic device satisfy a reference position for a duration longer than a threshold.

7. The method of claim 1, wherein identifying the configuration gesture comprises identifying movement in a single dimension.

8. The method of claim 1, wherein the configuration position is identified only after collecting measurements that match the configuration position for a time duration that matches a predefined condition.

9. The method of claim 1, further comprising receiving a password or another code from the other device when the other device requests permission to connect with the mobile electronic device via the wireless network.

10. The method of claim 1, wherein the ad-hoc wireless network is assigned a name, wherein the name comprises a unique identifier of the mobile electronic device.

11. The method of claim 1, further comprising the other device receiving a management interface via the ad-hoc wireless network wherein the management interface enables the other device to input data into a configurable memory address of the electronic device.

12. The method of claim 1, wherein the management interface is a browser or a dedicated software application capable of remotely controlling applications operating on the mobile electronic device.

13. The method of claim 1, further comprising:
securing the mobile electronic device by a configuration device;
the configuration device moving the mobile electronic device according to the configuration gesture;
the configuration device releasing the mobile electronic device.

14. The method of claim 13, wherein the configuration device releases the mobile electronic device on a movable surface that carries the mobile electronic device to a storage location.
